(19) United States
(12) Patent Application Publication
(10) Pub. No.: US 2011/0142401 A1
(43) Pub. Date: Jun. 16, 2011

(54) CABLE ASSEMBLY WITH IMPROVED FIBER TERMINATING MEANS

(75) Inventors: HSIEN-CHU LIN, Tu-Cheng (TW); CHI-NAN LIAO, Tu-Cheng (TW)

(73) Assignee: HON HAI PRECISION INDUSTRY CO., LTD., Tu-Cheng (TW)

(21) Appl. No.: 12/964,750

(22) Filed: Dec. 10, 2010

(30) Foreign Application Priority Data
Dec. 10, 2009 (TW) 98142334

(51) Int. Cl. G02B 6/36

(52) U.S. Cl. 385/77

(57) ABSTRACT

A cable assembly includes an insulative housing (1); a plurality of terminals (2) retained in the insulative housing; a lens (3) mounted to the insulative housing, and the lens defining a mounting slot (332) extending along an axial direction; a cable including at least one fiber (81), the fiber having front end with an inclined surface (811), the fiber inserted into the mounting slot; and optical adhesive (38) applied to the mounting slot to combine the fiber and the lens together.

### FIELD OF THE INVENTION

The present invention generally relates to a cable assembly, and more particularly to a cable assembly for optical signal transmitting.

### DESCRIPTION OF PRIOR ART

In many of today's processing systems, such as personal computer (PC) systems, there exist universal serial bus (USB) ports for connecting various USB devices. Some of these USB devices are frequently used by PC users. For example, these USB devices may be printers, compact disk read-only-memory (CD-ROM) drivers, digital versatile disk (DVD) drivers, cameras, keyboards, joy-sticks, hard-drives, etc. Different standards of USB technology have different bandwidths. For instance, Universal Serial Bus Specification, revision 1.1 devices are capable of operating at 12 Mbits/second(Mbps). Universal Serial Bus Specification, revision 2.0 devices are capable of operating at 480 Mbps. However, as technology progresses engineers are constantly striving to increase operating speeds.

CN Pat. No. 101345358 published on Jan. 14, 2009 discloses an optical USB connector which has a fiber device added to a USB connector. Thus, the optical USB connector can transmit electrical signals and optical signals. The fiber device includes a lens with a mounting hole therein for receiving a front portion of the fiber, and optical adhesive is applied to the mounting hole for combining the lens and the fiber together. However, there exists a gap between a front end of the fiber and a bottom side of the lens, and air bubble may be trapped therebetween, which may result in transmitting loss, and affect optical signal transmitting.

Hence, an improved cable assembly is highly desired to overcome the aforementioned problems.

### SUMMARY OF THE INVENTION

Accordingly, an object of the present invention is to provide a cable assembly with an improved fiber terminating means advancing optical signal transmitting.

In order to achieve the object set forth, a cable assembly in accordance with the present invention comprises an insulative housing; a plurality of terminals retained in the insulative housing; a lens mounted to the insulative housing, and the lens defining a mounting slot extending along an axial direction; a cable including at least one fiber, the fiber having front end with an inclined surface, the fiber inserted into the mounting slot; and optical adhesive applied to the mounting slot to combine the fiber and the lens together.

Other objects, advantages and novel features of the invention will become more apparent from the following detailed description when taken in conjunction with the accompanying drawings.

### BRIEF DESCRIPTION OF THE DRAWINGS

FIG. 1 is an assembled, perspective view of the cable assembly;

FIG. 2 is a partially assembled view of the cable assembly;

FIG. 3 is an exploded, perspective view of FIG. 2;

FIG. 4 is similar to FIG. 3, but viewed from another aspect;

FIG. 5 is other partially assembled view of the cable assembly;

FIG. 6 is a top side view of FIG. 5;

FIG. 7 is a back side view of FIG. 2;

FIG. 8 is a partial cross-section view of FIG. 1 taken along line 8-8; and

FIG. 9 is a partially enlarged view of terminating area between a fiber and a lens.

### DETAILED DESCRIPTION OF PREFERRED EMBODIMENTS

Reference will now be made in detail to the preferred embodiment of the present invention.

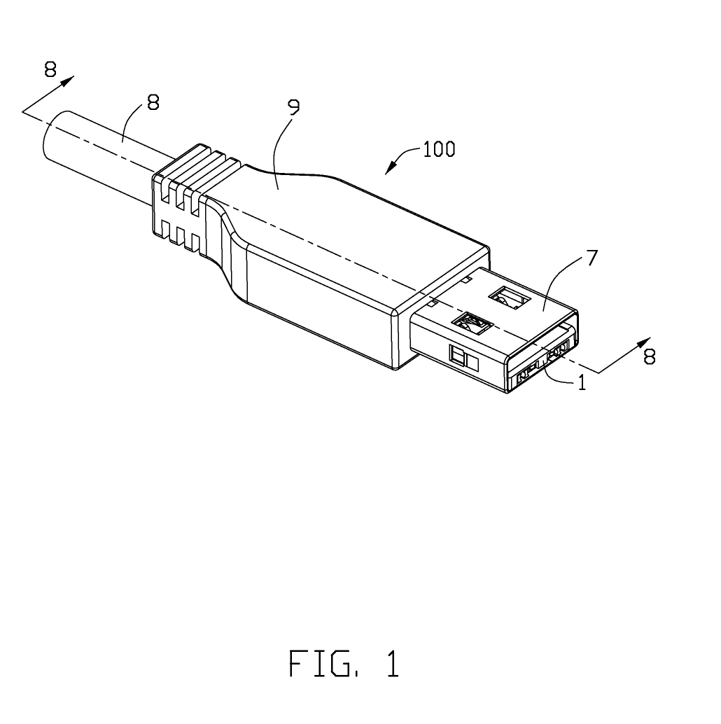

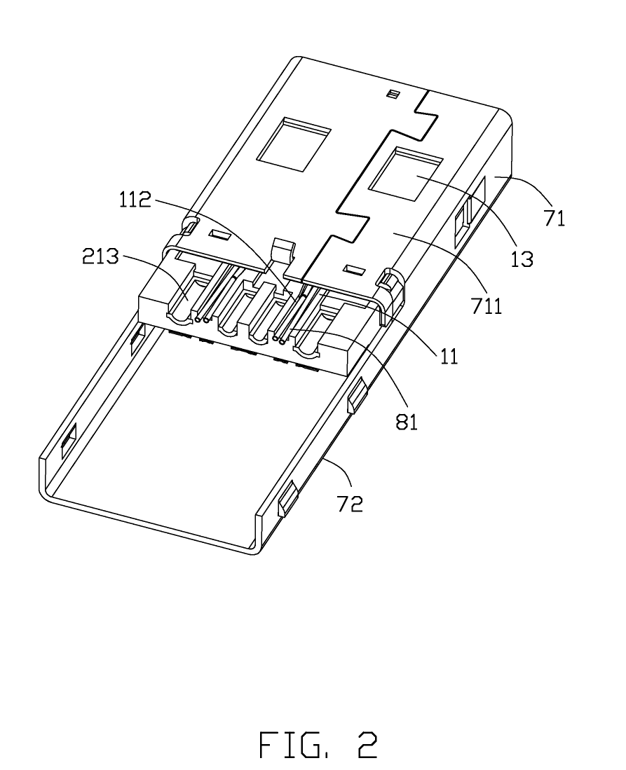

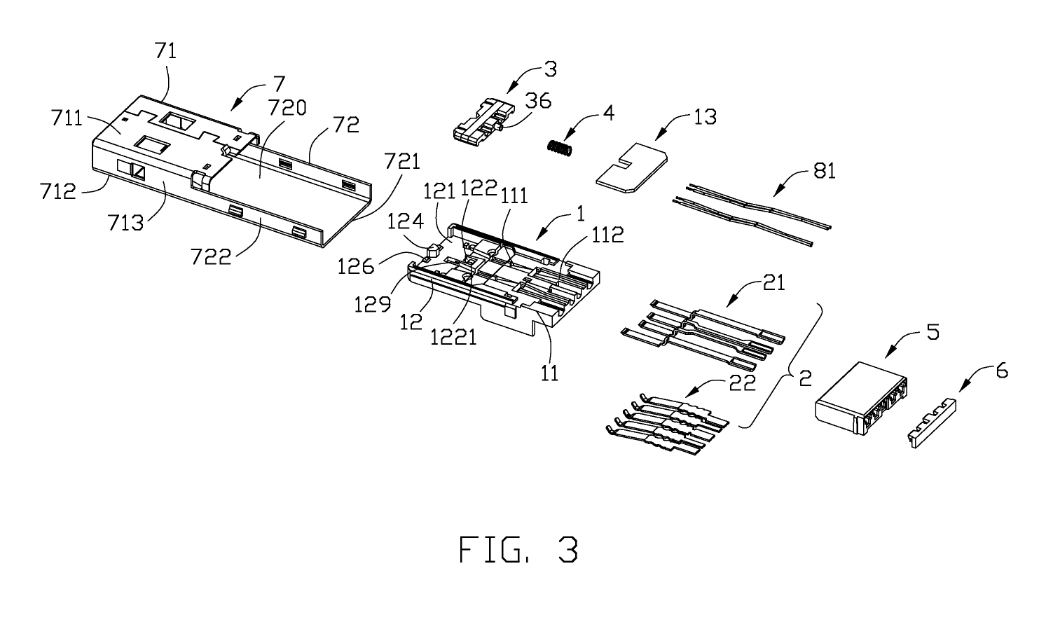

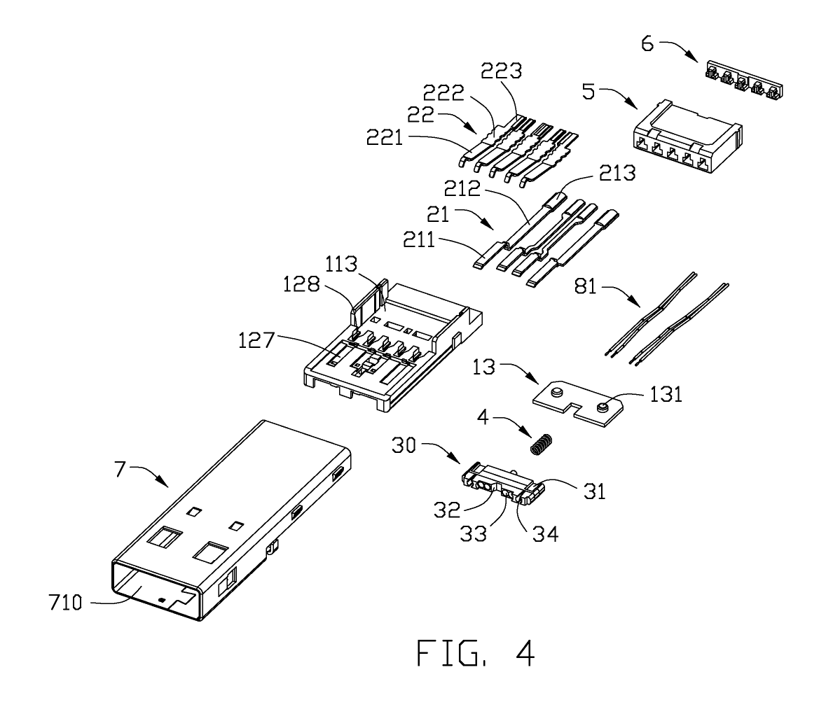

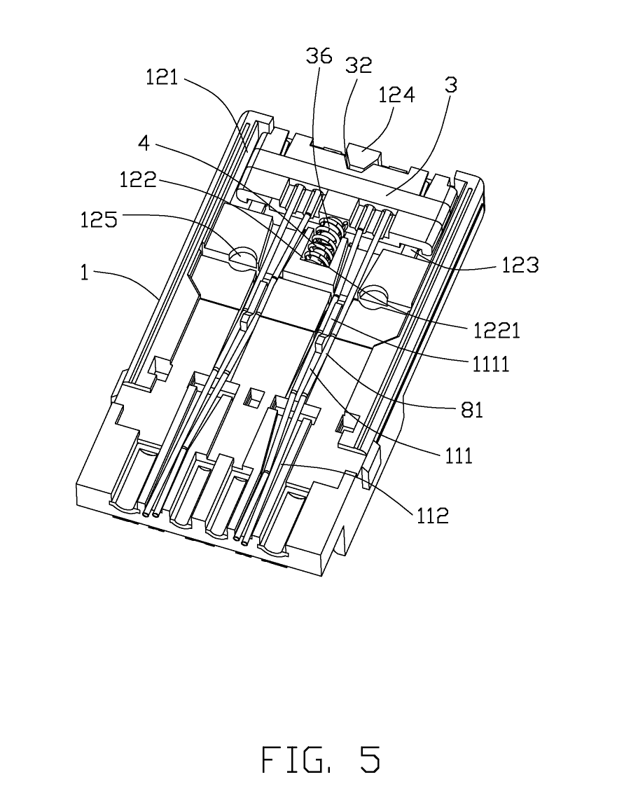

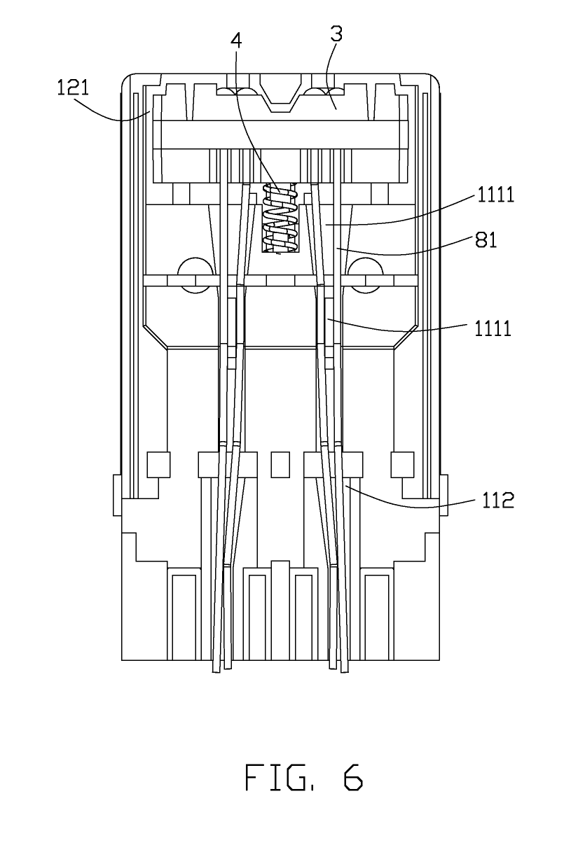

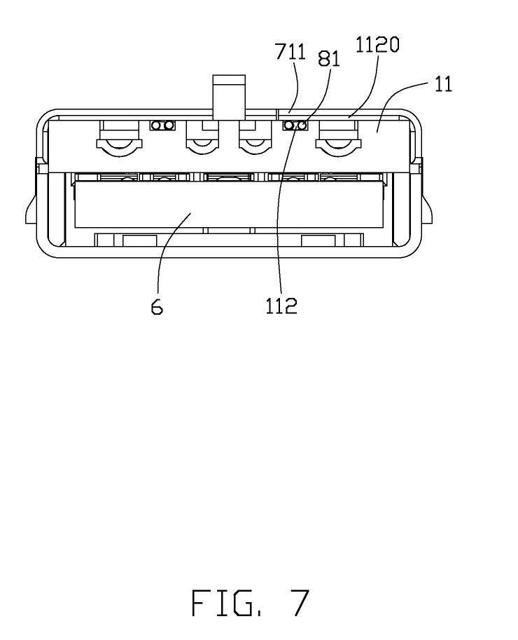

Referring to FIGS. 1-9, a cable assembly 100 in accordance with the present invention comprises an insulative housing 1, a plurality of terminals 2 retained in the insulative housing 1, an optical module 3 mounted to the insulative housing 1, an elastic member 4 sandwiched between the insulative housing 1 and the optical module 3 so as to forwardly bias the optical module 3, a terminal seat 5, a spacer 6, a metallic shell 7 shrouding the insulative housing 1, a cable 8 connecting with the terminals 2 and the optical module 3 and an external cover 9 partially enclosing the metallic shell 7 and the cable 8.

The insulative housing 1 includes a main portion 11 and a tongue portion 12 extending forwardly from the main portion 11.

There are two fiber passages 111 in a top side of a back segment of the tongue portion 12 and a front segment of the main portion 11. Each fiber passage 111 is of tapered shape along front-to-back direction. A front part is wider than a back part of the fiber passage 111. There is a rib 1111 formed in a middle part of the fiber passage 111 and the rib 1111 also extends along the front-to-back direction. There are two retaining slots 112 located in a back segment of the main portion 11. The retaining slot 112 is also configured to be tapered shape along the front-to-back segment. Furthermore, the retaining slot 112 communicates with the fiber passage 111. There is a recess 113 located in a bottom side of the main portion 11. The terminal seat 5 is accommodated in the recess 113. There is a cavity 121 defined in a top side of a front segment of the tongue portion 12. Also, there is a groove 122 defined in the tongue portion 12 and disposed behind the cavity 121. The groove 122 communicates with the cavity 121 too, and the cavity 121 further communicates with the fiber passages 111. A post 1221 is located in the groove 122 and projects forwardly.

The elastic member 4 is a coil spring. A rear segment of the elastic member 4 is accommodated in the groove 122, with the post 1221 being inserted into therein. Two guiding members 123 are arranged in lateral sides of the cavity 121. A notch 129 is located in the cavity 121 and disposed in front of the groove 122, so as to provide enough space for a front segment of the elastic member 4 floating along up-to-down direction. There is a V-shaped stopper 124 located in middle segment of a front end of the tongue portion 12. There are two protrusions 126 disposed at opposite sides of the stopper 124. A set of first terminal grooves 127 and a set of second terminal grooves 128 defined in a bottom side of the tongue portion. The first terminal grooves 127 are disposed in front of the second terminal grooves 128.

An arrangement of the terminals 2 is in accordance with USB 3.0 standard. The terminals 2 are divided into a set of first terminals 21 and a set of second terminals 22. The first terminals 21 and the second terminals 22 are separated into two distinct rows along the front-to-back direction.

The set of first terminals 21 have four contact members arranged in a row along the transversal direction. Each first terminal 21 substantially includes a planar retention portion 212 supported by a bottom surface of the recess 113, a mating portion 211 raised upwardly and extending forwardly from the retention portion 212 and received in the corresponding first terminal groove 127, and a tail portion 213 extending rearward from the retention portion 212.

The set of second terminals 22 have five contact members arranged in a row along the transversal direction and combined with the terminal seat 5. The set of second terminals 22 are separated into two pairs of signal terminal for transmitting differential signals and a grounding terminals disposed between the two pair of signal terminals. Each second terminal 22 includes a planar retention portion 222 received in the terminal seat 5, a curved mating portion 221 extending forward from the retention portion 222 and disposed beyond a front surface of the terminal seat 5, and a tail portion 223 extending rearward from the retention portion 222 and disposed behind a back surface of the terminal seat 5. The spacer 6 is assembled to the terminal seat 5, with a number of ribs (not numbered) thereof inserted into the grooves (not numbered) of the terminal seat 5 to position the second terminals 22.

The optical module 3 includes four lens members 33 arranged in juxtaposed manner and mounted to a base portion 30. In addition, there are two guiding grooves 31 located in lateral parts of a bottom side of the base portion 30. The base portion 30 further defines a cutout 32 in middle segment of a front side thereof. Two alignment holes 34 are respectively located in lateral segments of the front side. A mounting post 36 protrudes backwardly from a middle of a back side of the base portion 30. The optical module 3 is accommodated in the cavity 121, with the mounting post 36 inserted into a front segment of the elastic member 4. The guiding members 123 cooperate with the guiding grooves 31, when the optical module 3 moving in the cavity 121. The stopper 124 is accommodated in the cutout 32 to prevent the optical module 3 escaping from the insulative housing 1. The protrusions 126 may support the optical module 3.

The cable 8 includes four fibers 81 and a number of copper wires (not shown). The fibers 81 extend into the fiber passages 111 via the retaining slots 112 and are respectively coupled to the lenses 33 of the optical module 3. The copper wires are connected to the tail portions 213, 223 of the first terminals 21 and the second terminals 22. As the fiber passages 111 are configured to be tapered shape, thus there are enough space for the fibers 81 to be flexible therein. In addition, the fibers 81 are properly inhibited within the fiber passages 111. There are two fibers 81 received in one of the fiber passages 111, and the two fibers 81 are spaced apart from each other by the rib 1111, therefore, they do not twist together. There is also a cap 13 mounted to the insulative housing 1 to shield the fibers 81. The cap 13 has two positioning members 131 formed at a bottom surface thereof and inserted into positioning holes 125 defined in the insulative housing 1. As the optical module 3 and the terminals 2 are arranged at opposite sides of the insulative housing 1, hence it facilitates manufacturing proceeding.

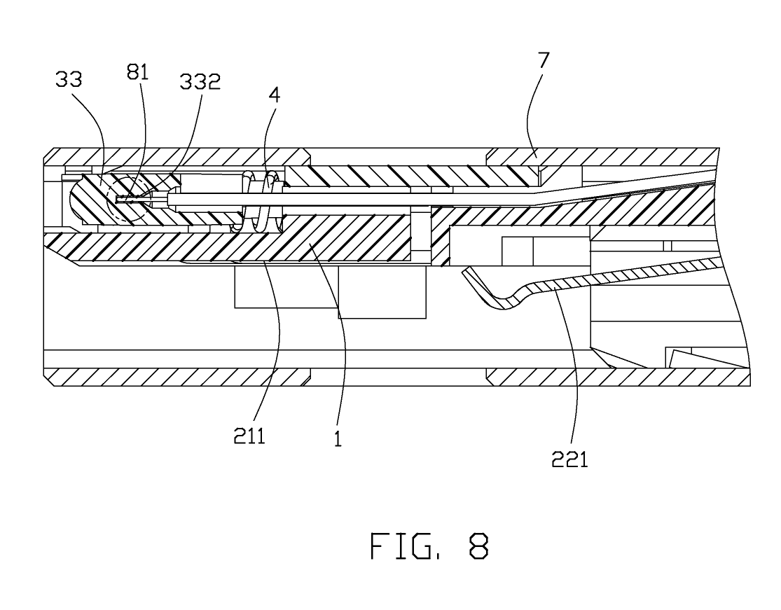

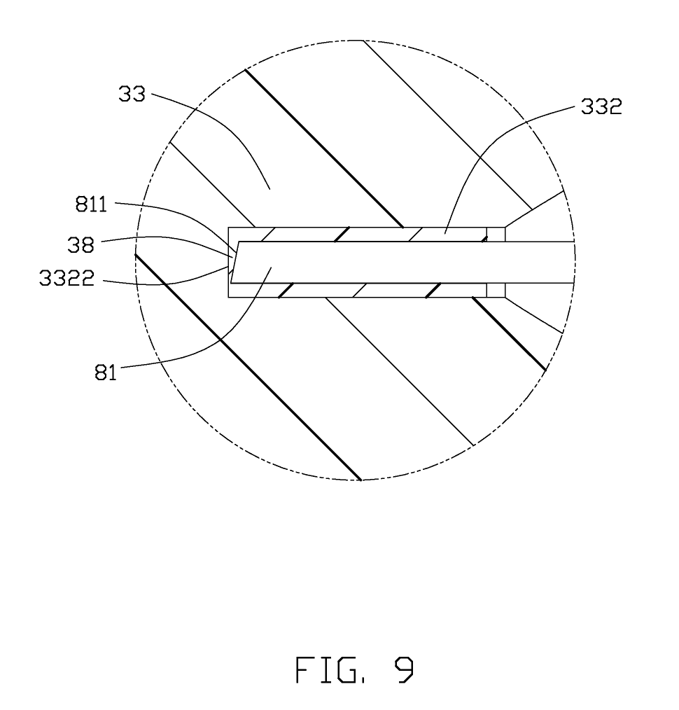

Referring to FIGS. 8-9, there is a mounting slot 332 defined in the lens 33, the mounting slot 332 extends along an axial direction. A front segment of the fiber 81 is inserted into the mounting slot 332 of a corresponding lens 33. In addition, a front end of the fiber 81 is trimmed to form an inclined surface 811. The inclined surface 811 is oblique to an axis of the fiber 81. Therefore, a wedged gap (not numbered) is formed between the front end of the fiber and the bottom side 3322 of the mounting slot 332. Thus, when the front end of the fiber 81 is disposed proximate to a bottom/inner side 3322 of the mounting slot 332, and optical adhesive 38 is applied to the mounting slot 332, then the optical adhesive 38 fills the wedged gap between the fiber 81 and the bottom side 3322 of the mounting slot 332. As there is enough space between the front end of the fiber 81 and the bottom side 3322 of the mounting slot 332, no air bubble is formed.

The metallic shell 7 includes a frame 71 and a U-shaped portion 72 connected to the frame 71. The frame 71 has a top wall 711, a bottom wall 712 and a pair of side walls 713 joining with the top wall 711 and the bottom wall 712 to form a hollow 710. The U-shaped portion 72 extends backwardly from the frame 71 and has a bottom side 721 and two lateral sides 722 upwardly protruding from two lateral edges of the bottom side 721 to form a receiving space 720.

The insulative housing 1 is assembled to the metallic shell 7, with the tongue portion 12 and the front segment of the main portion 11 received in the hollow 710 of the frame 71, the back segment of the main portion 11 accommodated in the U-shaped portion 72. The top wall 711 is disposed proximate to the back segment of the main portion 11, therefore, a gap 1120 formed between the top wall 711 and the back segment of the main portion 11 is minimized. Furthermore, the gap 1120 is smaller than a diameter of the fiber 81, therefore, the fiber 81 is restrained in the retaining slots 112. There may be an inverted U-shaped portion mounted to the U-shaped portion 72.

However, in alternative embodiment, the lens 33 may be mounted to the insulative housing 1 directly, and accordingly the base portion 30 may be only a portion of the insulative housing 1 to fill with the cavity 121.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A cable assembly, comprising:
an insulative housing;
a plurality of terminals retained in the insulative housing;
a lens mounted to the insulative housing, and the lens defining a mounting slot extending along an axial direction;
a cable including at least one fiber, the fiber having front end with an inclined surface, the fiber inserted into the mounting slot; and
optical adhesive applied to the mounting slot to combine the fiber and the lens together.

2. The cable assembly as recited in claim 1, wherein the front end of the fiber is disposed proximate to a bottom side of the mounting slot.

3. The cable assembly as recited in claim 2, wherein there is a wedged gap formed between the bottom side of the mounting slot and the front end of the fiber, and the optical adhesive is filled in the wedged gap.

4. The cable assembly as recited in claim 1, wherein the terminals are divided into a set of first terminals and a set of second terminals.

5. The cable assembly as recited in claim 4, wherein the set of first terminal and the set of second terminals offset from each other along a front-to-back direction.

6. A cable assembly, comprising:
an insulative housing having a main portion and a tongue portion extending forwardly from the main portion, a cavity defined in the tongue portion;
an optical module accommodated in the cavity, the optical module including at least one lens enclosed in a base portion thereof, and the lens defining a mounting slot extending along an axial direction;
a cable including at least one fiber inserted into the mounting slot of the lens, and a wedged gap formed between a front end of the fiber and a bottom side of mounting slot; and
optical adhesive applied to the mounting slot and filling in the wedged gap.

7. The cable assembly as recited in claim 6, wherein the front end of the fiber is trimmed to form an inclined surface.

8. The cable assembly as recited in claim 6, wherein there is an elastic member sandwiched between the optical module and the insulative housing for biasing the optical module forward movement.

9. The cable assembly as recited in claim 8, wherein there is a mounting post protruding backwardly from the base portion and inserted into a front portion of the elastic member.

10. The cable assembly as recited in claim 9, wherein there is a post located in a groove which is defined in the tongue portion and the post is inserted into a back portion of the elastic member.

11. The cable assembly as recited in claim 10, wherein the elastic member is a coil spring.

12. The cable assembly as recited in claim 6, wherein there is a fiber passage located in the insulative housing and disposed behind the cavity, and the fiber extends through the fiber passage and is coupled to the lens.

13. The cable assembly as recited in claim 12, wherein the fiber passage is tapered along a front-to-back direction.

14. The cable assembly as recited in claim 13, wherein there is a cap mounted to the insulative housing to shield the fiber.

15. A cable assembly comprising:
an insulative housing;
a plurality of terminals retained in the housing;
a lens disposed in the housing and defining a mounting slot along an axial direction;
an optical fiber inserted into the mounting slot; and
optical adhesive filled in the mounting slot beside the optical fiber; wherein
a gap, which is located between the lens and a front end of the fiber in the axial direction and is filled with the optical adhesive, defines an interface with one of the lens and the front end of the fiber under condition that said interface is oblique to the axial direction.

16. The cable assembly as claimed in claim 15, wherein said gap defines another interface with the other of the lens and the front end of the fiber under condition that said another interface is perpendicular to said axial direction.

17. The cable assembly as claimed in claim 16, wherein said gap defines a wedged configuration.
